(19) United States
(12) Patent Application Publication
(10) Pub. No.: US 2026/0134698 A1
(43) Pub. Date: May 14, 2026

(54) SYSTEMS, PROGRAM PRODUCTS, AND METHODS FOR DETERMINING VIABLE MERGING SEGMENTS FOR AUTONOMOUS VEHICLES USING A NEURAL NETWORK MODEL

(71) Applicant: Torc Robotics, Inc., Blacksburg, VA (US)

(72) Inventor: Harish Karunakaran, Austin, TX (US)

(21) Appl. No.: 18/947,813

(22) Filed: Nov. 14, 2024

(51) Int. Cl. G06V 20/56; B60W 60/00; G06T 7/10; G06V 10/26; G06V 10/82

(52) U.S. Cl. CPC G06V 20/588; B60W 60/0015; G06T 7/10; G06V 10/26; G06V 10/82; B60W 2420/403; G06T 2207/20081; G06T 2207/20084; G06T 2207/30256

(57) ABSTRACT

An autonomous vehicle includes sensor(s) configured to acquire sensor data of an environment surrounding the autonomous vehicle, where the autonomous vehicle operates within the environment. The autonomous vehicle also includes an autonomy computing system including a processor(s) programmed to divide lanes in the environment into segments of a predetermined longitudinal length and determine attributes of at least one of the segments. The processor(s) also analyzes, using a neural network model, the segments and attributes associated with the segments, where the neural network model is configured to receive input segments represented with the attributes as inputs and output a viable segment among the input segments to merge into. Furthermore, the processor(s) determines a viable segment among the segments to merge the autonomous vehicle into, based on the analysis, and controls operation of the autonomous vehicle based on the viable segment.

### TECHNICAL FIELD

The field of the disclosure relates generally to autonomous vehicles and, more specifically, systems, program products, and methods for determining viable segments or gaps for autonomous vehicle.

### BACKGROUND OF THE INVENTION

In driving, situations of merging into a lane often arise. For an autonomous vehicle, the process of merging typically includes identifying gaps in a target lane in which the autonomous vehicle targets to merge, identifying a viable gap among the gaps, selecting the gap to merge in, and performing the merging. In at least some conventional methods, an analytical method is used for the merging process, where the merging process is simulated with parameters and analytical relationships among them to address various scenarios. Analytical methods, however, encounter difficulties in developing a stable analytical model that considers as many real-world scenarios as possible while. As such, there is a need for improved systems and methods for merging of autonomous vehicles.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed autonomous vehicle includes one or more sensors configured to acquire sensor data of an environment surrounding the autonomous vehicle, where the autonomous vehicle operates in the environment. The autonomous vehicle also includes an autonomy computing system in communication with the one or more sensors. The autonomy computing system includes at least one processor in communication with at least one memory device. The at least one processor is programmed to divide lanes in the environment into segments of a predetermined longitudinal length, and determine attributes of at least one of the segments, based on the sensor data. The at least one processor is also programmed to analyze, using a neural network model, the segments and attributes associated with the segments, wherein the neural network model is configured to receive input segments represented with the attributes as inputs and output a viable segment among the input segments to merge into. Additionally, the at least one processor is also programmed to determine a viable segment among the segments to merge the autonomous vehicle into, based on the analysis, and control operation of the autonomous vehicle based on the viable segment.

In another aspect, the disclosed one or more non-transitory computer-readable storage mediums for determining a viable segment of lanes in an environment in which an autonomous vehicle is traveling, includes a plurality of instructions stored thereon that, in response to being executed, cause a system to divide lanes in the environment into segments of a predetermined longitudinal length, and determine attributes of at least one of the segments based on sensor data acquired by one or more sensors of the autonomous vehicle. The sensor data is of the environment surrounding the autonomous vehicle. The system also analyzes, using a neural network model, the segments and attributes associated with the segments, wherein the neural network model is configured to receive input segments represented with the attributes as inputs and output a viable segment among the input segments to merge into. Additionally, the system determines a viable segment among the segments to merge the autonomous vehicle into, based on the analysis, and controls operation of the autonomous vehicle based on the viable segment.

In yet another aspect, the disclosed computer-implemented method for determining a viable segment of lanes in an environment in which an autonomous vehicle is traveling includes dividing lanes in an environment into segments of a predetermined longitudinal length, the autonomous vehicle operating in the environment. The method also includes determining attributes of at least one of the segments based on sensor data acquired by one or more sensors of the autonomous vehicle, where the sensor data of the environment surrounding the autonomous vehicle. Additionally, the method includes analyzing, using a neural network model, the segments and attributes associated with the segments, wherein the neural network model is configured to receive input segments represented with the attributes as inputs and output a viable segment among the input segments to merge into. Furthermore, the method includes determining a viable segment among the segments to merge the autonomous vehicle into, based on the analysis, and controlling operation of the autonomous vehicle based on the viable segment.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 is an ariel view of an autonomous vehicle and traffic vehicles traveling within an environment including a road;

FIG. 4 is a flowchart showing an example method for determining a viable segment for an autonomous vehicle using a neural network;

FIG. 5 is a schematic diagram of a neural network model;

FIG. 6 is a schematic diagram of a neuron in the neural network model shown in FIG. 5;

FIG. 7 is a schematic diagram of an example convolutional neural network model; and

FIG. 8 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

In at least some conventional methods, analytical mechanisms are used in controlling the merging process for an autonomous vehicle, where the merging process is simulated with parameters and analytical relationships among the parameters to address various scenarios. Analytical mechanisms face difficulties in developing stable analytical models that apply to as many real-world scenarios as possible. Real-world driving includes a myriad of scenarios. It is difficult to narrow down the parameters or develop analytical relationships among the parameters that would represent all of the various scenarios, and to tune the simulated model under various scenarios. Further, the number of parameters needs to be increased to cover an increased number of scenarios. For example, the number of parameters may be 400 or more. As the number of parameters increase, the complexity of the relationships and difficulties in tuning increase. Changing parameters and/or relationships to fit one scenario may render the model unfit for another scenario. In addition, analytical mechanisms have difficulties in processing occluded sections of the road because by definition, occluded sections lack data or information due to being occluded from sensors of the autonomous vehicle.

Autonomous vehicles discussed herein address the above described problems in analytical methods for merging, and facilitate improved control and/or operation while merging. Specifically, the autonomous vehicle defines a plurality of segments of the environment surrounding the autonomous vehicle. Additionally, the autonomous vehicle utilizes detected sensor data relating to the environment, the autonomous vehicle itself, and/or objects (e.g., traffic vehicles) included within the environment to determine attributes of the segments. The determined attributes and corresponding sensor data is then provided to a neural network model to analyze and ultimately generate or determine at least one viable segment among the segments to merge the autonomous vehicle into. As used herein, “viable segments” of the road may include a gap, portion or a plurality of portions of the road in which the autonomous vehicle may safely and/or efficiently move or merge into while traveling. Occlusion is included as an attribute of a segment, thereby including occlusion into the neural network model. The viable segment(s) or gap(s) indicates paths in which the autonomous vehicle safely moves within the environment and/or substantially minimize and/or prevent collisions with objects (e.g., traffic vehicles) within the environment. The neural network model is trained using annotated real-world merge data. In training a neural network model, the training data should be a relatively large dataset such that the trained neural network model is not underfitted, where the model is too simple to capture the underlying patterns, and should include a myriad of varieties in scenarios such that the model is not overfitted, where the model is too closely trained to a specific dataset to predict with new data. The merge data may be any data that a vehicle successfully merges into a lane, and are not limited to autonomous vehicles. Therefore, real-world merge data are abundantly available. Another advantage of real-world merge data is that real-world merge data includes a myriad of varieties in merging scenarios. Therefore, the systems and methods described herein are advantageous in reducing underfitting and overfitting, thereby increasing the accuracy of the model, by providing a neural network model for determining a viable segment for merging trained with merge data. The merge data are annotated to determine ground truth in the merge data by identifying or labeling the viable segment in the merge data. In some embodiments, besides real-world merge data, merge data include simulated travel or movement of a vehicle that are successful and/or safe within various environments. A convolutional neural network may be used in the systems and methods described herein. Compared to other neural network models, such as fully-connected neural network models, utilizing the convolutional neural network model is advantageous in reducing computation and/or processing time and power, thus allowing for faster determination of viable segments for the autonomous vehicle. Moreover, the convolutional neural network model enables the system to determine viable segments for the autonomous vehicle at approximately 10 Hertz (Hz) or higher (e.g., generating outputs in 0.1 seconds or less), facilitating online determination of merging with improved operation and/or safety for the autonomous vehicle traveling within the environment. As used here, being online refers to that computation and/or determination by the autonomy computing system of the autonomous vehicle being performed while the autonomous vehicle is operating or travelling in an environment.

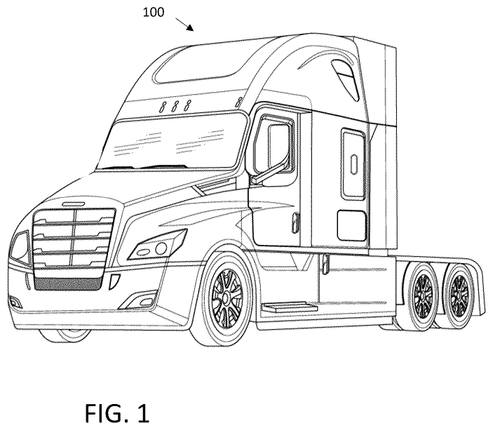

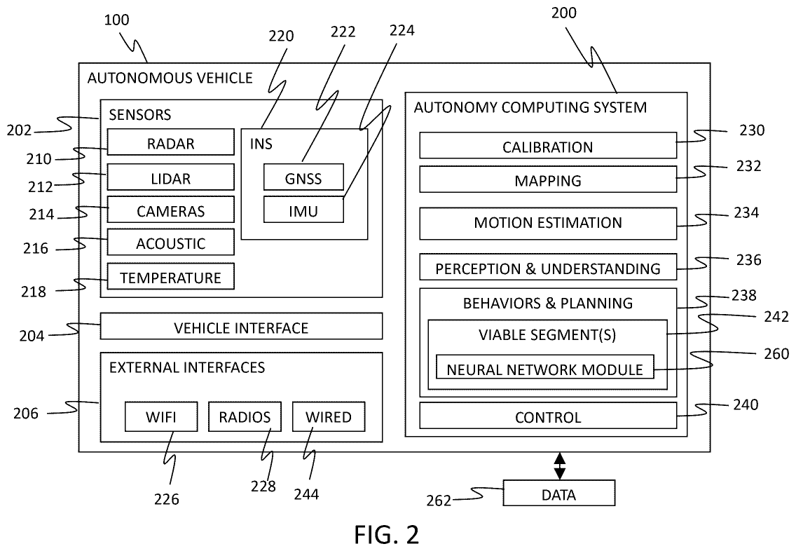

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV has any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 captured and represented in the LiDAR point clouds. Radar sensors 210 may include short-range radar (SRR), mid-range radar (MRR), long-range radar (LRR), or ground-penetrating radar (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a viable segment module 242. Viable segment module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Viable segment module 242 facilitates the determination of viable segments for autonomous vehicle 100 based on sensor data obtained by sensors 202. For example, the determination of at least one viable segment for autonomous vehicle 100 within the environment, using viable segment module 242, determines or identifies viable segments of a road for autonomous vehicle 100 to merge and/or travel into during operation of autonomous vehicle 100. “Viable segments” of the road may include a gap, portion or a plurality of portions of the road in which autonomous vehicle 100 may safely and/or efficiently move or merge into while traveling. Viable segment module 242 receives, for example, sensor data relating to an environment (e.g., road), autonomous vehicle, and/or data relating to object(s) (e.g., traffic vehicles, objects) within the environment to generate and/or determine viable segments for autonomous vehicle 100, which includes segments or portions of the road that are viable to receive autonomous vehicle 100 and/or provide enough space for autonomous vehicle 100 to travel or move into during operation. Viable segment module 242 may also facilitate the adjusting of real-time driving characteristics and/or control the operation of autonomous vehicle 100 when viable segments are determined and/or identified within the environment in which autonomous vehicle 100 is traveling within.

Additionally in non-limiting examples, viable segment module 242 of autonomy computing system 200 for autonomous vehicle 100 relies on and/or utilizes a neural network model 260 to facilitate the determination of the viable segments for autonomous vehicle 100 during operation, as discussed herein. Neural network model 260 may be a convolutional neural network model. In one example, neural network model 260 includes two convolutional layers and a fully connected layer to output one or more viable segments among the input segments. Neural network model 260 may be trained in autonomy computing system 200. Alternatively or additionally, neural network model 260 is trained on a computing device separate from autonomous vehicle 100. The trained neural network model 260 is deployed to viable segment module 242.

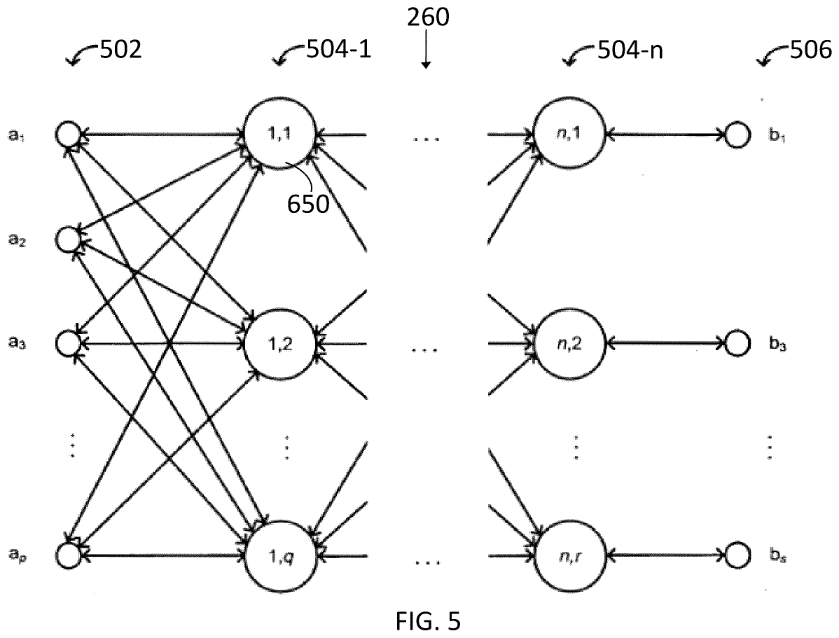

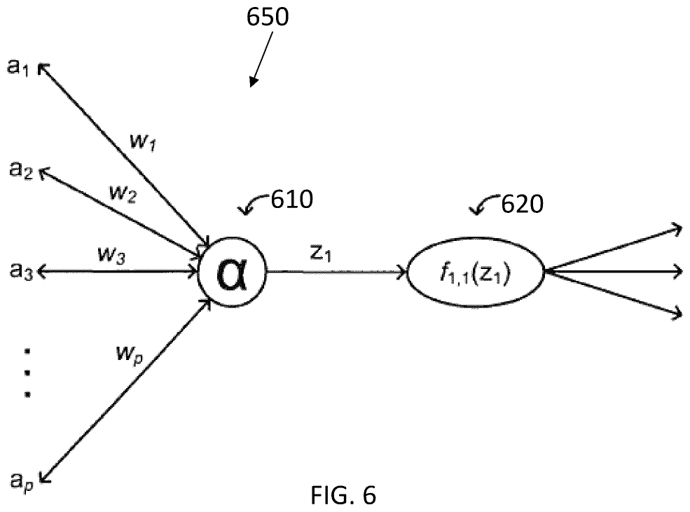

Additionally in some embodiments, and as discussed herein, neural network model 260 includes a convolutional neural network model including one or more layers of neurons (see, FIGS. 5 and 6, described later) configured to determine viable segments for autonomous vehicle 100 based on sensor data detected and/or acquired by sensors 202. Neural network model 260 may be trained with annotated merge data 262. That is, during training, annotated merge data relating to a plurality of previous and/or simulated annotated travel movements for autonomous vehicle 100 and/or a vehicle substantially similar to autonomous vehicle 100 are used for training, where the merge data 262 is the inputs to neural network model 260. In example embodiments, data 262 used to train neural network model 260 include, but is not limited to, previously generated or determined viable segments for autonomous vehicle 100, previously detected travel or movements of a non-autonomous vehicle (e.g., a traffic vehicle similar to autonomous vehicle 100), and/or previously simulated travel or movement of autonomous vehicle 100 of vehicles similar to autonomous vehicle 100. These previously determined viable segments, previously detected travel or movement patterns, and/or previously simulated travel or movement of merge data 262 correspond to and/or include successful mergers and/or movement of autonomous vehicle 100/similar vehicles within various environments (e.g., roads). Additionally, merge data 262 used for training neural network model 260 also include at least a portion of the similar sensor data detected by sensors 202, as discussed herein.

Autonomy computing system 200 of autonomous vehicle 100 may be completely autonomous (fully autonomous), semi-autonomous, or with any level of autonomy. In one example, autonomy computing system 200 operates under Level 5 autonomy (e.g., full driving automation), Level 4 autonomy (e.g., high driving automation), or Level 3 autonomy (e.g., conditional driving automation), Level 2 autonomy (e.g., partial driving automation), or Level 1 autonomy (e.g., driver assistance) As used herein the term “autonomous” includes fully autonomous, semi-autonomous, or having any level of autonomy.

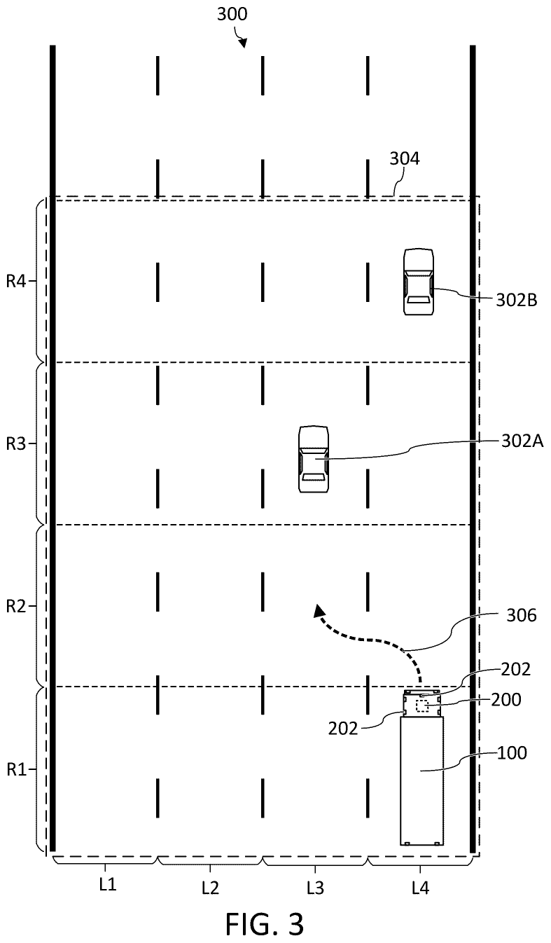

FIG. 3 is an aerial view of a portion of a road 300 including at least one traffic vehicle 302A, 302B and autonomous vehicle 100. A traffic vehicle refers to any other vehicle in the environment in which autonomous vehicle 100 is operating. In the example, road 300 includes a first lane (L1), a second lane (L2) formed adjacent first lane (L1), a third lane (L3) formed adjacent second lane (L2), and a fourth lane (L4) formed adjacent third lane (L3). As shown, traffic vehicle 302A is traveling in the third lane (L3) of road 300, while traffic vehicle 302B is traveling in the fourth lane (L4). Traffic vehicle 302B is ahead of and/or traveling in front of traffic vehicle 302A. In the non-limiting example shown in FIG. 3, traffic vehicles 302A, 302B are passenger cars or vehicles that are piloted or controlled by a driver and used to transport passengers and their belongs. In other non-limiting examples, traffic vehicles 302A, 302B include any road-approved vehicle including motorcycles, box-trucks, tractor-trailers, and the like. Additionally, although discussed herein as being controlled by a driver, it is understood that traffic vehicles 302A, 302B may include an autonomous vehicle as well.

Autonomous vehicle 100 is traveling along road 300 within the fourth lane (L4). In a non-limiting example, autonomous vehicle 100 is an autonomous or self-driving vehicle (e.g., autonomous cargo truck), as similarly discussed herein with respect to FIGS. 1 and 2. As shown in FIG. 3, autonomous vehicle 100 is behind both traffic vehicles 302A, 302B. More specifically, autonomous vehicle 100 is to the side of, and behind traffic vehicle 302A traveling in third lane (L3), as well as, aligned with and behind traffic vehicle 302B traveling in fourth lane (L4).

As shown in FIG. 3, autonomous vehicle 100 includes at least one autonomy computing system 200, as discussed herein with respect to FIG. 2. The at least one computing system 200 is electronically coupled and/or communicatively connected to various systems and/or components of autonomous vehicle 100. For example, and as discussed herein, autonomous vehicle 100 includes and/or is in electronic communication with at least one sensor 202. In the non-limiting example, autonomous vehicle 100 includes a plurality of sensors 202 positioned around and/or disposed on various portions of autonomous vehicle 100. As shown in the example in FIG. 3, sensors 202 are disposed on, positioned on, and/or coupled to an exterior of autonomous vehicle 100, adjacent to a front end of autonomous vehicle 100. In other non-limiting examples, sensors 202 also may be positioned adjacent a back end of autonomous vehicle 100 as well. Sensors 202 obtain, gather, and/or receive data regarding surrounding traffic vehicles 302A, 302B and/or objects positioned adjacent autonomous vehicle 100 as autonomous vehicle 100 travels along road 300. The sensor data obtained and/or detected by sensors 202 are processed by autonomy system 200 and are utilized to determine viable segment(s) for autonomous vehicle 100, as discussed herein. As similarly discussed herein, sensors 202 are configured or formed as a variety of sensors including, but not limited to, radar sensors 210, LiDAR sensors 212, cameras 214, acoustic sensors 216, and/or temperature sensors 218 (see, FIG. 2).

Autonomy computing system 200 and/or sensors 202 of autonomous vehicle 100, at least in part, define a plurality of areas or segments 304 (hereafter, “segments 304”) of autonomous vehicle 100. The predetermined or defined plurality of segments 304 are areas adjacent to and/or surrounding autonomous vehicle 100 in which sensors 202 obtain or detect sensor data about objects traveling within and/or adjacent to road 300, and/or road 300 itself. For example, sensors 202 of autonomous vehicle 100 detect sensor data for traffic vehicles 302A, 302B traveling within the plurality of defined segments 304 and/or detected data about the plurality of lanes (L1-L4) of road 300 to facilitate the determination of viable segment(s) for autonomous vehicle 100, as discussed herein. The defined plurality of segments 304 are arranged in a plurality of rows and a plurality of columns. That is in a non-limiting example, each of the lanes (L1-L4) of road 300 are divided into distinct segments. The columns of the plurality of segments 304 correspond to each of the distinct, identified lanes (L1-L4) of road 300, while the rows are defined and/or determined based on a predetermined, longitudinal length (PL). In the example embodiment shown in FIG. 3, the plurality of defined segments 304 form four (4) distinct columns. Each column and/or lane (L1-L4) included in the defined plurality of segments 304 also includes a number of distinct rows (R1, R2, R3, R4) as well. In the example embodiment, the plurality of segments 304 have four (4) distinct rows (R1, R2, R3, R4). As a result, the plurality of segments 304 defined by autonomous vehicle 100 and/or autonomy computing system 200 include a 4×4 arrangement which yields sixteen (16) segments 304 that are analyzed to facilitate the determination of at least one viable segment for autonomous vehicle 100, as discussed herein. Each object included within the plurality of segments 304 is therefore designated by a position identifier comprising a column or lane identifier (e.g., “L1,” “L2,” “L3,” “L4) and a row identifier (e.g., “R1,” “R2,” “R3,” “R4”). In the example embodiment shown in FIG. 3, autonomous vehicle 100 is positioned and/or traveling within segment 304-L4, R1, while traffic vehicle 302A is positioned and/or traveling within segment 304-L3, R3. Traffic vehicle 302B is positioned and/or traveling within segment 304-L4, R4. In other implementations, the plurality of segments 304 may be any size/uniformity/arrangement (e.g., 2×2, 3×3, etc.), and the number of segments for the plurality of segments 304 may vary depending upon a number of rows and columns.

The size or PL of each defined segment 304 is dependent, at least in part on, the types of sensors 202, the number of sensors 202, and/or the position or placement of sensors 202 on autonomous vehicle 100. As discussed herein, the detection of object data specific to each traffic vehicle 302A, 302B and/or road 300, as detected within the segments 304, facilitate the determination of viable segment(s) for autonomous vehicle 100 while traveling on road 300. Additionally, or alternatively, the size or PL of each defined segment 304 is dependent or based on, at least in part, characteristics of road 300 (e.g., number of lanes), and/or the length of autonomous vehicle 100. That is, and as discussed herein, PL is substantially equal to a length of autonomous vehicle (AVL) 100. In example embodiments, and as discussed herein, having the PL equal to AVL of autonomous vehicle 100 ensures the merge patterns generated by autonomy computing system 200 include a desired spacing and/or merge pattern for autonomous vehicle 100 on road 300. Additionally, having PL equal to AVL of autonomous vehicle 100 makes certain autonomous vehicle 100 travels and/or moves within road 300 (e.g., change lanes) during operation with minimized or eliminated risk of contacting traffic vehicle 302A, 302B. In other non-limiting examples (see, FIGS. 6A-6D), PL varies and/or may be distinct from AVL of autonomous vehicle 100.

Sensors 202 positioned on autonomous vehicle 100 collect, detect, monitor, acquire, and/or gather sensor data relating to an environment (e.g., road 300) surrounding autonomous vehicle 100, autonomous vehicle 100 included within the environment, and/or at least one object (e.g., traffic vehicles 302A, 302B) included within the environment. For example, sensors 202 of autonomous vehicle 100 detect sensor data for and/or relating to road 300 on which autonomous vehicle 100 is traveling. Additionally, or alternatively, sensors 202 of autonomous vehicle 100 detect data for and/or relating to autonomous vehicle 100 and/or traffic vehicles 302A, 302B detected and/or identified on road 300, adjacent autonomous vehicle 100. The sensor data detected by sensors 202 is further processed, analyzed, and/or evaluated by autonomy computing system 200 to translate the acquired sensor data into tangible and/or meaningful data that may be used by autonomy computing system 200 of autonomous vehicle 100 during operation and/or to facilitate determining viable segment(s) 304 for autonomous vehicle 100. For example, sensor data detected by sensors 202 relating to road 300, autonomous vehicle 100, and/or traffic vehicles 302 may be processed by autonomy computing system 200 to define attributes for each of the plurality of segments 304 to be further analyzed by neural network model 260 (see, FIG. 2), as discussed herein.

In non-limiting examples, detected and/or processed sensor data, as well as determined and/or generated data based on the acquired sensor data, is utilized and/or analyzed to determine attributes of at least one of the segments 304 for road 300. The acquired sensor data and/or determined data based on the acquired sensor data includes, but is not limited to, a velocity or speed of traffic vehicles 302A, 302B traveling within and/or occupying at least one segment 304 on road 300, an acceleration of traffic vehicles 302A, 302B traveling within and/or occupying at least one segment 304 on road 300, occlusion of segment(s) 304 on road 300 of whether segment 304 is occluded from autonomous vehicle 100, a position of segment 304 within road 300 (e.g., segment 304-L1, R1, segment 304-L1, R2, etc.), a Boolean value of occupancy of segments 304 (e.g., traffic vehicle 302B present in segment 304-L4, R4=“1”), a lane identification of each segment 304 (e.g., first lane (L1), second lane (L2), etc.), a Boolean value of segment 304 being occupied by the autonomous vehicle (e.g., autonomous vehicle 100 present in segment 304-L4, R1=“1”), and the like. Although examples of acquired sensor data and/or determinations using acquired sensor data are included herein, it is to be understood that data detected and/or acquired by sensors 202 of autonomous vehicle 100 may be any suitable data that is utilized by computing system 200 of autonomous vehicle 100 for facilitating the determination of viable segments for autonomous vehicle 100 traveling on road 300, as discussed herein.

Autonomy computing system 200 of autonomous vehicle 100 facilitates determining viable segment(s) 304 for autonomous vehicle 100 traveling along road 300 during operation. For example, and as discussed herein, autonomy computing system 200, including neural network model 260 (see, FIGS. 2 and 5-7), is configured to utilize/analyze acquired sensor data relating to road 300, autonomous vehicle 100 traveling on road 300, and/or traffic vehicles 302A, 302B positioned within defined segments 304. Autonomy computing system also determines attributes associated with each segment 304, to determine a viable segment among the segments 304 to merger autonomous vehicle 100 traveling on road 300 into during operation. The determined viable segment(s) provide safe travel or movement of autonomous vehicle 100 that substantially minimize and/or prevent collisions with traffic vehicle(s) on road 300. With reference to FIG. 3, example processes for determining the viable segment(s) 304 for autonomous vehicle 100 during operation are discussed herein.

Maps depicting actors, including traffic vehicles 302A, 302B and autonomous vehicle 100 are generated based on sensor data. A map includes lanes and actors in corresponding lanes and in specific segments of each lane. In the non-limiting example shown in FIG. 3, based on sensor data, viable segment module 242 (see, FIG. 2) determines that road 300 includes four (4) distinct lanes (L1-L4), determines each of the four (4) distinct lanes (L1-L4) with respect to the position of autonomous vehicle 100 on road 300, and determines that there are no changes, alternations, and/or modifications of the portion of road 300 included within the defined plurality of segments 304 (e.g., no merging lanes). Additionally, and based on sensor data, it is determined that in the example shown in FIG. 3, at least segment 304-L2, R3 is occluded by traffic vehicle 302A. That is, occluded segment 304-L2, R3 includes a portion of road 300 and/or one of the plurality of segments 304 that is occluded to sensors 202 because traffic vehicle 302A positioned within segment 304-L3, R3 occludes the view from sensors 202. As a result, data specific to road 300 and/or potential traffic vehicle(s) 302A, 302B or objects (e.g., debris, cones) positioned within occluded segment 304-L2, R3 may not be detected. It should be understood that additional segments (e.g., segment 304-L1, R3, segment 304-L2, R4) may also be occluded to sensors 202/autonomous vehicle 100 as a result of traffic vehicle 302A being positioned within segment 304-L3, R2. Based on sensor data, viable segment module 242 determines a position and/or distance of each of the plurality of segments 304 from autonomous vehicle 100. For example, it is determined that segment 304-L4, R2 is directly adjacent to and/or “one” segment adjacent to segment 304-L4, R1 including autonomous vehicle 100. Additionally, based on sensor data, viable segment module 242 determines segment 304-L1, R4 is diagonally opposite to and/or at least three segments separated from segment 304-L4, R1 including autonomous vehicle 100.

Moreover, and based on sensor data, viable segment module 242 determines a Boolean value of occupancy of each segment of the plurality of segments 304 defined in road 300. More specifically, viable segment module 242 determines and/or defines a Boolean value associated with the occupancy of each segment of the plurality of segments 304 that are not occluded. In the non-limiting example shown in FIG. 3, viable segment module 242 determines that both segment 304-L3, R3 and segment 304-L4, R4 include a Boolean value of “1,” as each segment 304-L3, R3, 304-L4, R4 is “occupied” as a result of detecting traffic vehicles 302A, 302B positioned therein. Additionally in the example, viable segment module 242 determines that non-occluded segments, for example segments 304-L3, R2, 304-L2, R1, 304-L4, R2, 304-L4, R3, and so on, include a Boolean value of “0” as each of segments 304-L3, R2, 304-L2, R1, 304-L4, R2, 304-L4, R3, etc. is “open” or “unoccupied” as a result of no objects being detected therein.

Based on sensor data, viable segment module 242 detects and/or determines that autonomous vehicle 100 occupies segment 304-L4, R1. As a result, a Boolean value of segment 304-L4, R1 is “1” as a result of autonomous vehicle 100 “occupying” and/or being positioned with segment 304-L4, R1. Furthermore, viable segment module 242 determines that autonomous vehicle 100 is traveling at a speed of approximately fifty-five (55) miles per hour (mph), and substantially no change (e.g., increase, decrease) in acceleration at the time of detection. Additionally, detected and/or known data includes AVL of autonomous vehicle 100.

Viable segment module 242 detects and/or determines that traffic vehicle 302A is traveling at a speed, such as approximately sixty (60) mph (97 km/h), with no acceleration at the time of detection. Furthermore, autonomy computing system 200 detects that traffic vehicle 302B is traveling at a speed, such as approximately forty (40) mph (64 km/h) and includes a decreasing acceleration at the time of detection. Additionally in the non-limiting example, viable segment module 242 determines and/or detects that traffic vehicle 302A is positioned within segment 304-L3, R3, while traffic vehicle 302B is positioned within segment 304-L4, R4. Viable segment module 242 also determine that both traffic vehicles 302A, 302B are passenger sedans, and/or may approximate each traffic vehicle's 302A, 302B size. Finally in example embodiments, viable segment module 242 determines, detects, and/or defines that traffic vehicle 302A is proximate to and/or a distance of two segment from autonomous vehicle 100, while traffic vehicle 302A is proximate to and/or a distance of approximately three segments from autonomous vehicle 100.

Subsequent to the determination of the attributes for each of the plurality of segments 304, the sensor data and determined attributes for each of the plurality of segments 304 for road 300 are analyzed using neural network model 260 (see, FIG. 2). More specifically, the determined attributes for each of the plurality of segments 304 for road 300, along with the detected sensor data relating to road 300, autonomous vehicle 100, and/or traffic vehicles 302, are provided to, and analyzed, evaluated, and/or assessed using, neural network model 260 trained with annotated merge data 262 (see, FIG. 2).

The annotated merge data 262 used to train neural network model 260 relates to and/or includes previously determined viable segments or gaps, and/or travel or movement for vehicles having similar lengths to autonomous vehicle 100. The annotated merge data 262 may include successful mergers and/or movement of any vehicles, either autonomous or nonautonomous vehicles.

Additionally, annotated merge data 262 used to train neural network model 260, as discussed herein, also includes data, information, and/or feedback used to define or determine attributes for each of the plurality of segments for the road. The annotated merge data 262 may be processed by dividing lanes into segments and determining attributes of at least one of the segments. The attributes for a segment may include, but not limited to: a velocity or speed of an object traveling within and/or occupying the segment, an acceleration of the object in the segment, occlusion of the segment, a position of the segment, a Boolean value of occupancy of the segment, a lane identification of the segment, a Boolean value of the segment being occupied by the vehicle that is performing the merging.

In the example embodiments discussed herein, merge data 262 is annotated or labelled with viable segments or the segments that the vehicles merge in. The labels or annotations are the ground truth of merge data 262. Neural network model 260 is training via a supervised training, where the annotated merge data are used to train neural network model. During training, segments and their attributes of merge data 262 are input into neural network model 260. Ground truths are compared with outputs from neural network model 260, and neural network model 260, such as weighting of the neurons, is learned and/or adjusted by optimizing a loss function, which is a function of errors between the ground truth and the outputs and of parameters of neural network model 260 to be adjusted.

The trained neural network model 260 is configured to analyze the provided data and the determined attributes to determine whether there is at least one viable segment of the plurality of segments 304 that may successfully and safely receive autonomous vehicle 100. The determined attributes for each of the plurality of segments, along with the data detected and/or defined by sensors 202/autonomy computing system 200 used to determine the attributes for each segment 304, are input to neural network model 260 for analysis, processing, and/or computation in order to determine a viable segment to merge autonomous vehicle 100 into. In the example, neural network model 260 outputs and/or determines whether there is a viable segment among the input segments to merge autonomous vehicle 100 into. The determination of a viable segment, and associated merge pattern 306 for autonomous vehicle 100 provide preferred, safe travel or movement patterns for autonomous vehicle 100 within the environment and/or along road 300 that substantially minimizes and/or prevents collisions with traffic vehicles 302A, 302B. For example, the generation of merge pattern 306 includes determining at least one viable segment of the plurality of segments 304 for the environment/road 300 surrounding autonomous vehicle 100 in which autonomous vehicle 100 is positioned within while traveling along road 300.

As shown in FIG. 3 and based on the analysis performed by neural network model 260, neural network model 260 determines a viable segment or gap for autonomous vehicle 100 is segment 304-L3, R2 of road 300. With the viable segment 304-L3, R2 determined by neural network model 260, a generated merge pattern 306 provides a path for autonomous vehicle 100 to merge out of the fourth lane (L4) including traffic vehicle 302B, and into the third lane (L3), behind traffic vehicle 302A. In the example embodiment shown and discussed herein with respect to FIG. 3, and based on the analysis performed by neural network model 260, the position of autonomous vehicle 100 and traffic vehicle 302B (e.g., fourth lane (L4)) and speed difference (e.g., 55 mph (97 km/h) v. 40 mph (64 km/h)) between autonomous vehicle 100 and traffic vehicle 302B, along with data 262, at least in part, influences neural network model 260 to determine segment 304-L3, R2 to be a viable segment of the plurality of segments 304, as discussed herein. Additionally, while second lane (L2) is also open and/or unoccupied by traffic vehicles 302, neural network model 260 may not determine any segment of second lane (L2) to be viable for autonomous vehicle 100 as a result of the attributes defining that segment 304-L2, R3 being occluded by traffic vehicle 302A.

Based on the viable segment of the plurality of segments 304 determined by neural network model 260, neural network model 260 also includes or generates instructions and/or guidelines for adjusting operational parameters and/or control operations of autonomous vehicle 100 to position autonomous vehicle 100 within the identified, viable segment. That is, subsequent to determining the viable segment 304-L3, R3 for autonomous vehicle 100, the operation of autonomous vehicle 100 is controlled, adjusted, and/or regulated based on merge pattern 306 generated by autonomy computer system 200. Autonomy computing system 200 subsequently adjusts operational parameters of autonomous vehicle 100 to ensure and/or facilitate autonomous vehicle 100 moving into the viable segment or gap (e.g., segment 304-L3, R2). In the example embodiment shown in FIG. 3, autonomy computing system 200 temporarily adjusts the speed of autonomous vehicle 100, and/or steers autonomous vehicle 100 into viable segment 304-L3, R2, behind traffic vehicle 302A.

Because neural network model 260 is trained with merge data 262 that include a myriad varieties of scenarios, the trained neural network model 260 is configured to provide a viable segment under a myriad varieties of scenarios with increased accuracy. The intensive computation in analytical methods is replaced with prediction by neural network model 260, greatly reducing computation load and increasing the speed of computation. As described above, neural network model 260 may be a convolutional neural network model. Compared to other types of neural network model, such as a fully-connected neural network model, a convolutional neural network model has a reduced number of neurons, thereby reducing the demand on computation load, memory, and power. Therefore, the use of neural network model 260 to determine a viable segment(s) of the plurality of segments 304 reduces computational time and/or reduces the computational burden on autonomy computing system 200 when operating autonomous vehicle 100 as a result of the reduced number of neurons and/or the targeted neural network model used solely to identify viable segments.

In other non-limiting examples, the predetermined longitudinal length of each of the plurality of segments 304 defined on road 300 is adjusted, altered, and/or tuned during operation of autonomous vehicle 100. For example, while autonomous vehicle 100 travels along road 300 with no additional traffic vehicles present, autonomy computing system 200 of autonomous vehicle 100 defines the plurality of segments 304 on road 300, as similarly discussed herein. However in doing so, the determined attributes for each of the plurality of segments 304, defined using detected data by sensors 202, indicates that all segments 304 are open and/or unoccupied. As such, multiple segments 304 are determined by neural network model 260 as viable segments for autonomous vehicle 100 to travel into and/or be positioned within.

In this instance, and to reduce computational and/or processing time and/or burden/power even further for neural network model 260, autonomy computing system 200 adjusts PL of each segment 304. For example, autonomy computing system 200 adjusts the predetermined longitudinal length to an adjusted longitudinal length by increasing PL of each of the plurality of segments 304 in response to neural network model 260 determining that each lane (L1-L4) is open based on determined viable segments. Once adjusted, autonomy computing system 200 and/or neural network model 260 performs similar processes as discussed herein for determining viable segments 304 for autonomous vehicle 100. For example, the lanes (L1-L4) of road 300 are divided into adjusted segments having the adjusted longitudinal length. Subsequently, attributes are determined for the adjusted segments, based on sensor data acquired by sensors 202 of autonomous vehicle 100. Using neural network model 260, the sensor data and attributes for each of the adjusted segments are analyzed to determine viable, adjusted segments for autonomous vehicle 100. Each of these processes for tuning the longitudinal length for segments 304 of road 300 (e.g., adjusting, dividing, determining, analyzing) are repeated until a criterion for autonomous vehicle 100 is met. In non-limiting examples, the criterion for autonomous vehicle 100 includes, but is not limited to, a confidence level (e.g., safe travel of autonomous vehicle 100 on road 300) and/or an operating frequency of neural network model 260 at or above a predetermined threshold (e.g., 98% confidence of a viable segment for autonomous vehicle 100, 10 Hz or greater processing frequency for neural network model 260).

In a non-limiting example, the increased predetermined longitudinal length reduces computational and/or processing time and/or processing burden/power as a result of decreasing the number of segments 304 in the plurality of defined segments 304. For example, and with comparison to FIG. 3 which includes 16 distinct segments, the predetermined length for each of the plurality of defined segments 304 are increased (e.g., adjusted longitudinal length for adjusted segments), while maintaining the same overall size of the detectable area (e.g., all segments 304) to include eight (8) distinct segments 304 (e.g., four lanes (L1-L4), two rows (R1, R2)). As such, less attributes and/or fewer corresponding sensor data is provided to and/or analyzed by neural network model 260 to determine a viable, adjusted segment, as discussed herein.

In some embodiments, an optimized predetermined length may be determined by adjusting the predetermined segment length when training neural network model 260 with merge data 262. The predetermined segment length is adjusted and merge data 262 are processed using the adjusted segment length. The processed merge data 262 are then used to train neural network model and an optimized predetermined length is selected when a criterion is met, such as a confidence level and the speed of neural network model meet a certain threshold, such as a 90 confidence level and 10 Hz or higher speed. In other embodiments, viable segment module 242 includes a plurality of neural network model 260, where each neural network model 260 is trained with merge data represented in segments of a different predetermined length and their attributes. Viable segment module 242 is configured to choose which neural network model 260 to apply, depending on density of objects in the environment. For example, one of neural network model 260 is trained with a relatively long predetermined segment length, for environments having reduced traffic, while another one of neural network model 260 is trained with a relatively short predetermined segment length, for environments having increased traffic. The numbers and/types of attributes in merge data 262 may be adjusted. Less attributes may be used for reduced traffic, while more attributes may be used for increased traffic.

In a non-limiting example, when an object, such as traffic vehicle 302A, is detected within the plurality of segments 304 including the adjusted PL, the plurality of segments 304 are maintained with the adjusted PL and perform similar processes for determining viable, adjusted segments for autonomous vehicle 100, as discussed herein.

Alternatively, and as a result of the detection of traffic vehicles 302A in any segment 304 including the adjusted predetermined length, each of the plurality of segments 304 for road 300 are readjusted back to being based on and/or substantially equal to AVL of autonomous vehicle 100. That is, in response to sensors 202 detecting traffic vehicle 302A within one of the plurality of segments 304 including the adjusted PL, autonomy computing system 200 readjusts the length of each segment 304 back to a previous PL.

In yet another example, the predetermined length of each segment 304 is only readjusted (e.g., decreased) in response to detecting a predefined number of traffic vehicles within the defined plurality of segments 304. For example, in a four (4) lane road 300, autonomy computing system 200 maintains the segments 304 to include the increased PL so long as two (2) or less traffic vehicles are detected. In response to three (3) or more traffic vehicles being detected, autonomy computing system 200 readjusts the predetermined length of each segment 304, as similarly discussed herein.

Additionally, or alternatively, the predetermined length of each of the plurality of segments may be adjusted based on environmental characteristics. For example, in addition to receiving data detected by sensors 202, autonomy computing system 200 receives and/or determines environmental characteristics relating to the environment/road 300 to determine if the predetermined length for the plurality of segments 304 should be adjusted. Environmental characteristics relating to the environment/road 300 includes, but are not limited to, a time of day in which autonomous vehicle 100 is traveling within environment/road 300, populous data/population density (e.g., city/county resident numbers, people per square mile, etc.) surrounding the portion of road 300 including the plurality of segments 304, and the like

In additional non-limiting examples, the number and/or type of data used to determine attributes may also be adjusted. For example, the number and/or type of data for determining attributes for each of the plurality of segments 304 for road 300 may be adjusted, altered, and/or changed based on the density of objects in the environment and/or on road 300. For example, in response to only a single traffic vehicle 302 being detected by sensors 202, data considered and/or analyzed to determine attributes for each of the plurality of segments 304 is adjusted or reduced to only include the Boolean value of occupancy of the segment, and a Boolean value of the segment being occupied by the autonomous vehicle. Based on the adjusted number and/or types of data, adjusted attributes may be determined for each of the segments 304, and neural network model 260 analyzes the segments and adjusted attributes to determine viable segments for autonomous vehicle 100.

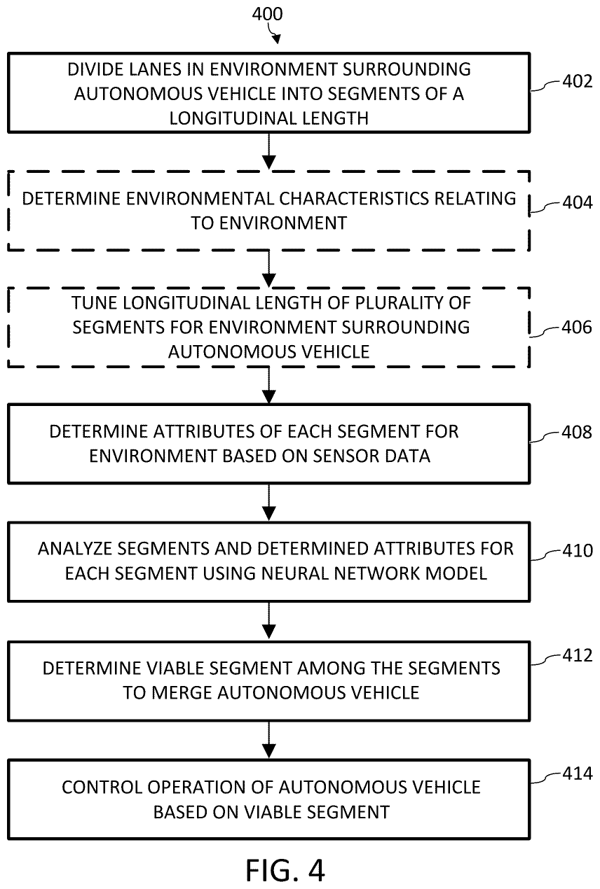

FIG. 4 is an example of processes 400 for improving the operation of autonomous vehicles. Specifically, FIG. 4 shows a flowchart depicting one example process for operation of autonomous vehicles by determining a viable segment on a road for the autonomous vehicle to merge into using a neural network model. In some cases, the processes may be performed using autonomous vehicle 100, as discussed above with respect to FIGS. 1-3, and autonomy computing system 200 shown and discussed herein with respect to FIG. 2.

In process 402, lanes of a road in which the autonomous vehicle is traveling are divided into a plurality of segments. That is, a plurality of segments for the environment surrounding the autonomous vehicle and/or for the road in which the autonomous vehicle is traveling along are defined, identified, divided into, and/or outlined using, for example, an autonomy computing system included in the autonomous vehicle. Each of the plurality of segments for the environment and/or road include a predetermined longitudinal length. In an example embodiment, the predetermined longitudinal length for each of the plurality of segments is based upon, at least in part, a length of the autonomous vehicle. In one example, the predetermined length of each of the segments, formed by dividing the lanes of the road, is substantially equal to the length of the autonomous vehicle.

In process 404, shown in phantom as optional, environmental characteristics relating to the environment in which the autonomous vehicle is traveling are determined. More specifically, environmental characteristics relating to the environment and/or road in which the autonomous vehicle is traveling are determined, defined, and/or identified. Determined environmental characteristics include, but are not limited to, a time of day in which autonomous vehicle is traveling within the environment and/or on the road, populous data (e.g., population) for the environment in which the autonomous vehicle is traveling, and the like.

In process 406, shown in phantom as optional, the predetermined longitudinal length of each of the plurality of segments (e.g., process 402) are tuned and/or adjusted based on the determined environmental characteristics (e.g., process 404). That is, the predetermined longitudinal length for each of the plurality of segments for the environment surrounding the autonomous vehicle are adjusted, altered, tuned, and/or changed based on the environmental characteristics determined in process 404. For example, a predetermined longitudinal length of each of the plurality of segments may be increased as a result of the time of day in which the autonomous vehicle is traveling within the environment corresponds to lower traffic volume (e.g., 2:00 AM), and/or the autonomous vehicle is traveling within an environment that is not heavily populated (e.g., rural farmlands v. city highways). In the example, adjusting the predetermined length of each of the plurality of defined segments decreases the computational time and/or reduces the computational burden or load on the autonomy computing system for determining attributes for each segment (e.g., process 408) and/or determining viable segments for the autonomous vehicle (e.g., process 412), as discussed herein.

In process 408, attributes for the plurality of segments for the environment are determined. More specifically, attributes for each of the plurality of segments for the environment defined in process 402 are defined, identified, determined, and/or assigned using, for example, the autonomy computing system of the autonomous vehicle. In example embodiments, the attributes for each of the plurality of segments are based on sensor data detected and/or acquired by at least one sensor included in the autonomous vehicle. The sensor data relates to the environment surrounding the autonomous vehicle, the autonomous vehicle included within the environment, and/or at least one object included within the environment. For example, the data may include, but is not limited to, a velocity of an object occupying the segment, acceleration of the object occupying the segment, occlusion of the segment, a position of the segment, a Boolean value of occupancy of the segment, a lane identification of the segment, or a Boolean value of the segment being occupied by the autonomous vehicle, and the like. Using the sensor data, attributes for each of the plurality of segments are determined, defined, identified, and/or assigned.

In process 410, the determined attributes for the plurality of segments for the environment are analyzed. The attributes, along with the sensor data used to determine the attributes, and the segments are provided to and subsequently analyzed by a neural network model. The neural network model provided with the determined attributes for each of the plurality of segments is trained with merge data. In the non-limiting example, the ground truths provided to the neural network model include, but are not limited to, annotations to the merge data provided for training. For example, the ground truths formed as annotated data indicates and/or identifies to the neural network model scenarios where a successful merger took place, as well as scenarios that were unsuccessful and/or where it was determined that an autonomous vehicle/similar vehicle did not move into a distinct segment.

In process 412, at least one viable segment for the autonomous vehicle is determined. More specifically, viable segment(s) for the autonomous vehicle is determined, defined, and/or output based on the analysis of the attributes for each of the plurality of segments for the environment using the neural network model. The determined viable segment(s) provides preferred, safe merge patterns for the autonomous vehicle within the environment and/or along the road that substantially minimizes and/or prevents collisions with objects (e.g., traffic vehicle(s)) also on the road. As such, and in example embodiments, the determined viable segment for the autonomous vehicle may also include a segment of the plurality of segments for the environment surrounding the autonomous vehicle in which the autonomous vehicle may be positioned and/or travel within.

In process 414, the operation of the autonomous vehicle are controlled, adjusted, and/or regulated based on the viable segment determined by the neural network model in process 412. For example, subsequent to determining the viable segment for the autonomous vehicle, the operational parameters of the autonomous vehicle are controlled and/or adjusted such that the autonomous vehicle follow a generated merge pattern based on the determined viable segment to position the autonomous vehicle in the identified, viable segment of the plurality of segments for the environment. Controlling the operation and/or adjusting operational parameters of the autonomous vehicle ensures and/or facilitates moving the autonomous vehicle into the identified, viable segment of the plurality of segments for the environment.

FIG. 5 depicts an example artificial neural network model 260. In the example embodiment, neural network model which includes layers of neurons 502, 504-1 to 504-n, and 506, including an input layer 502, one or more hidden layers 504-1 through 504-n, and an output layer 506. Each layer may include any number of neurons, i.e., q, r, and n in FIG. 5 may be any positive integers. It should be understood that neural networks of a different structure and configuration from that depicted in FIG. 5 may be used to achieve the methods and systems described herein.

In the example embodiment, input layer 502 may receive different input data. For example, input layer 502 includes a first input a1 representing training data, a second input a2 representing patterns identified in the data used in training and/or annotated data, a third input a3 represents determined viable segments for the sensor data, and so on. Input layer 502 may include thousands or more inputs. In some embodiments, the number of elements used by neural network model 260 changes during the training process, and some neurons are bypassed or ignored if, for example, during execution of the neural network, they are determined to be of less relevance.

In the example embodiment, each neuron in hidden layer(s) 504-1 through 504-n processes one or more inputs from input layer 502, and/or one or more outputs from neurons in one of the previous hidden layers, to generate a decision or output. Output layer 506 includes one or more outputs each indicating a label, confidence factor, weight describing the inputs, and/or an outputted viable segment(s). In some embodiments, however, outputs of neural network model 260 are obtained from a hidden layer 504-1 through 504-n in addition to, or in place of, output(s) from output layer(s) 506.

In some embodiments, each layer has a discrete, recognizable function with respect to input data. For example, if n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In other embodiments, the layers are not clearly delineated in terms of the functionality they perform. For example, two or more of hidden layers 504-1 through 504-n may share decisions relating to labeling, with no single layer making an independent decision as to labeling.

FIG. 6 depicts an example neuron 650 that corresponds to the neuron labeled as “1,1” in hidden layer 504-1 of FIG. 5, according to one embodiment. Each of the inputs to neuron 650 (e.g., the inputs in input layer 502 in FIG. 5) is weighted such that input a1 through ap corresponds to weights w1 through wp as determined during the training process of neural network model 260.

In some embodiments, some inputs lack an explicit weight, or have a weight below a threshold. The weights are applied to a function α (labeled by a reference numeral 610), which may be a summation and may produce a value z1 which is input to a function 620, labeled as f1,1(z1). Function 620 is any suitable linear or non-linear function. As depicted in FIG. 6, function 620 produces multiple outputs, which may be provided to neuron(s) of a subsequent layer or used as an output of neural network model 260. For example, the outputs may correspond to index values of a list of labels or may be calculated values used as inputs to subsequent functions.

It should be appreciated that the structure and function of neural network model 260 and neuron 650 depicted are for illustration purposes only, and that other suitable configurations exist. For example, the output of any given neuron may depend not only on values determined by past neurons, but also on future neurons.

Neural network model 260 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. Neural network model 260 may also or alternatively be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as merge data, object statistics, and information, as similarly discussed herein. The machine learning programs may use deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Based upon these analyses, neural network model 260 may learn how to identify characteristics and patterns that may then be applied to analyzing image data, model data, and/or other data. For example, neural network model 260 may learn to identify features in a series of data points.

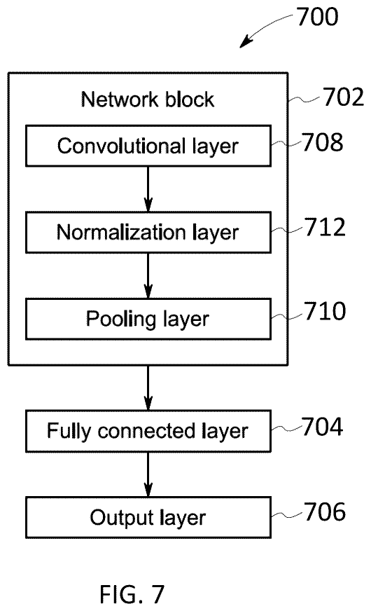

FIG. 7 is a block diagram of an example CNN 700 that may be included in neural network model 260. CNN 700 includes a convolutional layer 708. In a convolutional layer, convolution is used in place of general matrix multiplication in a neural network model. In one example, a 1×1 convolution is used to reduce the number of channels in CNN 700. CNN 700 includes one or more convolutional layer blocks 702, a fully connected layer 704 where the neurons in this layer is connected with every neuron in the prior layer, and an output layer 706 that provides outputs.

In the example embodiment, convolutional layer block 702 includes a convolutional layer 708 and a pooling layer 710. Each convolutional layer 708 is flexible in terms of its depth such as the number of convolutional filters and sizes of convolutional filters. Pooling layer 710 is used to streamline the underlying computation and reduce the dimensions of the data by combining outputs of neuron clusters at the prior layer into a single neuron in pooling layer 710. Convolutional layer block 702 may further include a normalization layer 712 between the convolutional layer 708 and the pooling layer 710. The normalization layer 712 is used to normalize the distribution within a batch of training merge data and update the weights in the layer after the normalization. The number of convolutional layer blocks 702 in CNN 700 may depend on the image quality of training merge data, and levels of details in extracted features.

In operation, in training, training data, merge patterns, and other data such as extracted features or information of the training data are inputted into one or more convolutional layer blocks 702. Observed masks corresponding to the training merge data are provided as outputs of output layer 706. CNN 700 is adjusted during the training. Once CNN 700 is trained, sensed or detected data is provided to the one or more convolutional layer blocks 702 and output layer 706 provides outputs that includes merge patterns for autonomous vehicle 100.

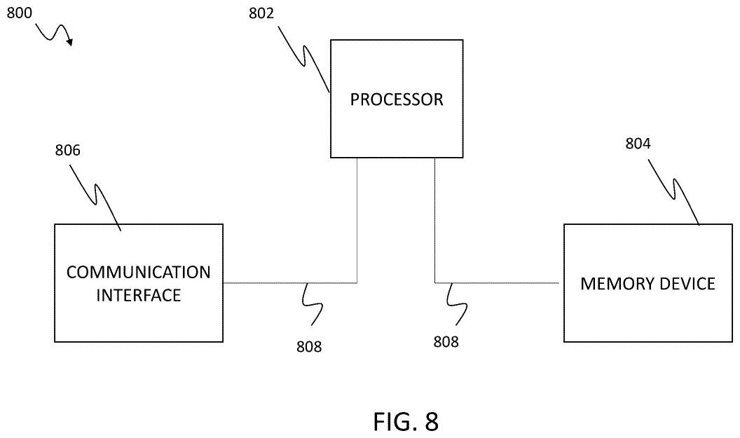

FIG. 8 is a block diagram of an example computing device 800. Autonomy system 200 may be implemented with one or more computing devices 800. Computing device 800 includes a processor 802 and a memory device 804. The processor 802 is coupled to the memory device 804 via a system bus 808. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 804 includes one or more devices that enable information, such as executable instructions or other data (e.g., sensor data), to be stored and retrieved. Moreover, the memory device 804 includes one or more computer readable media, such as, without limitation, dynamic random access memory (DRAM), static random access memory (SRAM), a solid state disk, or a hard disk. In the example embodiment, the memory device 804 stores, without limitation, application source code, application object code, configuration data, additional input events, application states, assertion statements, validation results, or any other type of data. The computing device 800, in the example embodiment, may also include a communication interface 806 that is coupled to the processor 802 via system bus 808. Moreover, the communication interface 806 is communicatively coupled to data acquisition devices.

In the example embodiment, processor 802 may be programmed by encoding an operation using one or more executable instructions and providing the executable instructions in the memory device 804. In the example embodiment, the processor 802 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the systems, program products, and methods for controlling and improving operation of an autonomous vehicle, as described herein, includes at least one of: (a) improving the safety and control of the autonomous vehicle by determining viable segments for the autonomous vehicle that that substantially minimize and/or prevent collisions with objects/traffic vehicle(s) on the road, (b) reduce computation and/or processing time for viable segments for the autonomous vehicle by utilizing a neural network trained using merge data, or (c) reduce computational and/or processing burdens or power requirements for determining viable segments for the autonomous vehicle by utilizing a convolutional neural network.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware may be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomous vehicle comprising:
one or more sensors configured to acquire sensor data of an environment surrounding the autonomous vehicle, the autonomous vehicle operating in the environment; and
an autonomy computing system in communication with the one or more sensors, the autonomy computing system comprising at least one processor in communication with at least one memory device, and the at least one processor programmed to:
divide lanes in the environment into segments of a predetermined longitudinal length;
determine attributes of at least one of the segments, based on the sensor data;
analyze, using a neural network model, the segments and attributes associated with the segments, wherein the neural network model is configured to receive input segments represented with the attributes as inputs and output a viable segment among the input segments to merge into;
determine a viable segment among the segments to merge the autonomous vehicle into, based on the analysis; and
control operation of the autonomous vehicle based on the viable segment.

2. The autonomous vehicle of claim 1, wherein the neural network model is a convolutional neural network model.

3. The autonomous vehicle of claim 1, wherein the at least one processor is further programmed to:
determine the attributes of a segment including at least one of a velocity of an object occupying the segment, acceleration of the object occupying the segment, occlusion of the segment, a position of the segment, a Boolean value of occupancy of the segment, a lane identification of the segment, or a Boolean value of the segment being occupied by the autonomous vehicle.

4. The autonomous vehicle of claim 1, wherein the neural network model is trained with annotated merge data.

5. The autonomous vehicle of claim 1, wherein the neural network model includes two convolutional layers.

6. The autonomous vehicle of claim 1, wherein the neural network model is configured to operate at approximately 10 Hz or higher.

7. The autonomous vehicle of claim 1, wherein the at least one processor is further programmed to:
tune the predetermined longitudinal length by:
adjusting the predetermined longitudinal length to an adjusted longitudinal length;
dividing the lanes into adjusted segments of the adjusted longitudinal length;
determining the attributes of at least one of the adjusted segments;
analyzing, using the neural network model, the adjusted segments and the attributes of the adjusted segments; and
repeating adjusting, dividing, determining, and analyzing until a criterion is met.

8. The autonomous vehicle of claim 1, wherein the at least one processor is further programmed to:
adjust at least one of a number or types of the attributes based on a density of objects in the environment;
determine adjusted attributes of the at least one of the segments; and
analyze, using the neural network model, the segments and the adjusted attributes, wherein the neural network model is retrained with training data represented with the segments associated with the adjusted attributes.

9. One or more non-transitory computer-readable storage mediums for determining a viable segment of lanes in an environment in which an autonomous vehicle is traveling, the one or more non-transitory computer-readable storage mediums comprising a plurality of instructions stored thereon that, in response to being executed, cause a system to:
divide lanes in the environment into segments of a predetermined longitudinal length;
determine attributes of at least one of the segments based on sensor data acquired by one or more sensors of the autonomous vehicle, the sensor data of the environment surrounding the autonomous vehicle;
analyze, using a neural network model, the segments and attributes associated with the segments, wherein the neural network model is configured to receive input segments represented with the attributes as inputs and output a viable segment among the input segments to merge into;
determine a viable segment among the segments to merge the autonomous vehicle into, based on the analysis; and
control operation of the autonomous vehicle based on the viable segment.

10. The one or more non-transitory computer-readable storage mediums of claim 9, wherein the neural network model is a convolutional neural network model.

11. The one or more non-transitory computer-readable storage mediums of claim 9, wherein the plurality of instructions stored thereon cause the system to determine the viable segment of lanes by:
determining the attributes of a segment including at least one of a velocity of an object occupying the segment, acceleration of the object occupying the segment, occlusion of the segment, a position of the segment, a Boolean value of occupancy of the segment, a lane identification of the segment, or a Boolean value of the segment being occupied by the autonomous vehicle.

12. The one or more non-transitory computer-readable storage mediums of claim 9, wherein the neural network model is trained with annotated merge data.

13. The one or more non-transitory computer-readable storage mediums of claim 9, wherein the neural network model includes two convolutional layers.

14. The one or more non-transitory computer-readable storage mediums of claim 9, wherein the neural network model is configured to operate at approximately 10 Hz or higher.

15. The one or more non-transitory computer-readable storage mediums of claim 9, wherein the plurality of instructions stored thereon cause the system to determine the viable segment of lanes by:
tuning the predetermined longitudinal length by:
adjusting the predetermined longitudinal length to an adjusted longitudinal length;
dividing the lanes into adjusted segments of the adjusted longitudinal length;
determining the attributes of at least one of the adjusted segments;
analyzing, using the neural network model, the adjusted segments and the attributes of the adjusted segments; and
repeating adjusting, dividing, determining, and analyzing until a criterion is met.

16. The one or more non-transitory computer-readable storage mediums of claim 9, wherein the plurality of instructions stored thereon cause the system to determine the viable segment of lanes by:
adjusting at least one of a number or types of the attributes based on a density of objects in the environment;
determining adjusted attributes of the at least one of the segments; and
analyzing, using the neural network model, the segments and the adjusted attributes, wherein the neural network model is retrained with training data represented with the segments associated with the adjusted attributes.

17. A computer-implemented method for determining a viable segment of lanes in an environment in which an autonomous vehicle is traveling, the method comprising:
dividing lanes in an environment into segments of a predetermined longitudinal length, the autonomous vehicle operating in the environment;
determining attributes of at least one of the segments based on sensor data acquired by one or more sensors of the autonomous vehicle, the sensor data of the environment surrounding the autonomous vehicle;
analyzing, using a neural network model, the segments and attributes associated with the segments, wherein the neural network model is configured to receive input segments represented with the attributes as inputs and output a viable segment among the input segments to merge into;
determining a viable segment among the segments to merge the autonomous vehicle into, based on the analysis; and
controlling operation of the autonomous vehicle based on the viable segment.

18. The method of claim 17, wherein determining the attributes further comprises:
determining the attributes of the segment including at least one of a velocity of an object occupying the segment, acceleration of the object occupying the segment, occlusion of the segment, a position of the segment, a Boolean value of occupancy of the segment, a lane identification of the segment, or a Boolean value of the segment being occupied by the autonomous vehicle.

19. The method of claim 17 further comprising:
tuning the predetermined longitudinal length by:
adjusting the predetermined longitudinal length to an adjusted longitudinal length;
dividing the lanes into adjusted segments of the adjusted longitudinal length; and
determining the attributes of at least one of the adjusted segments;
analyzing, using the neural network model, the adjusted segments and the attributes of the adjusted segments; and
repeating adjusting, dividing, determining, and analyzing until a criterion is met.

20. The method of claim 17 further comprising:
adjusting at least one of a number or types of the attributes based on a density of objects in the environment;
determining adjusted attributes of the at least one of the segments; and
analyzing, using the neural network model, the segments and the adjusted attributes, wherein the neural network model is retrained with training data represented with the segments associated with the adjusted attributes.
